(19) United States
(12) Patent Application Publication
(10) Pub. No.: US 2016/0253902 A1
(43) Pub. Date: Sep. 1, 2016

(54) PARKED VEHICLE DETECTION DEVICE, VEHICLE MANAGEMENT SYSTEM, AND CONTROL METHOD

(71) Applicant: KABUSHIKI KAISHA TOSHIBA, Minato-ku, Tokyo (JP)

(72) Inventors: Kentaro YOKOI, Tachikawa Tokyo (JP); Toshio SATO, Yokohama Kanagawa (JP); Nobuyuki OZAKI, Nishitokyo Tokyo (JP); Tatsuro ABE, Yokohama Kanagawa (JP); Yusuke TAKAHASHI, Tama Tokyo (JP); Hayato TODA, Komae Tokyo (JP)

(73) Assignee: KABUSHIKI KAISHA TOSHIBA, Minato-ku, Tokyo (JP)

(21) Appl. No.: 15/028,432

(22) PCT Filed: Oct. 8, 2014
(86) PCT No.: PCT/JP2014/076987

§ 371 Date: Apr. 10, 2016

(30) Foreign Application Priority Data
Oct. 11, 2013 (JP) 2013-214180

(51) Int. Cl. G08G 1/01; G08G 1/14

(52) U.S. Cl. CPC G08G 1/0133; G08G 1/0112; G08G 1/143

(57) ABSTRACT

A parked vehicle detection device includes a vehicle detector, a host-vehicle position detector, a position calculator, a vehicle information storage, and a parked vehicle determiner. The vehicle detector detects another vehicle included in an image of at least a front of a host vehicle, the image captured by an imaging device mounted on the host vehicle. The host-vehicle position detector detects a position of the host vehicle. The position calculator calculates a position of the detected another vehicle based on the detected position of the host vehicle. The vehicle information storage stores therein information on the another vehicle. The information includes the calculated position. The parked vehicle determiner determines whether the another vehicle is a high possible parked vehicle based on the information on the another vehicle.

### FIELD

Embodiments described herein relate generally to a parked vehicle detection device, a vehicle management system, and a control method.

### BACKGROUND

Conventionally, there is a proposed parked vehicle detection method for determining whether a vehicle is a parked vehicle by reading a vehicle number from images captured at different times with a camera installed in a mobile object such as a car (refer to Patent Literature 1).

Another proposed method is determining a parked vehicle with a plurality of measures including an operator's terminal input, a fixed camera, and an onboard camera (refer to Patent Literature 2).

However, the method disclosed in Patent Literature 1 cannot determine a parked vehicle or not when a number plate cannot be read because it is hidden or image quality is low.

The method disclosed in Patent Literature 2 requires the operator's inputs and cannot perform a determination in an area that cannot be imaged with the fixed camera.

In view of the above, an object of the present invention is to specify the position (detected position) of a parked vehicle and more accurately estimate or predict a road condition with a simple configuration.

### BRIEF DESCRIPTION OF DRAWINGS

FIG. 1 is a schematic configuration block diagram of a parked vehicle detection system according to a first embodiment;

FIG. 2 is a schematic configuration block diagram of a parked vehicle detection device according to the first embodiment;

FIG. 3 is a flowchart of the operation of the parked vehicle detection device according to the first embodiment;

FIG. 4A is an explanatory diagram (part 1) for distance correction;

FIG. 4B is an explanatory diagram (part 2) for distance correction;

FIG. 5 is an explanatory diagram for concept of stored vehicle information;

FIG. 6 is an explanatory diagram for determining a parked vehicle from a variance of inter-vehicle distances;

FIG. 7 is a schematic configuration block diagram of a parked vehicle detection device according to a second embodiment;

FIG. 8 is a flowchart of the operation of the parked vehicle detection device according to the second embodiment;

FIG. 9 is a schematic configuration block diagram of a parked vehicle detection device according to a third embodiment;

FIG. 10 is a flowchart of the operation of the parked vehicle detection device according to the third embodiment;

FIG. 11 is an explanatory diagram for determining a change in a traveling position from a steering amount;

FIG. 12 is an explanatory diagram for overtake of the parked vehicle;

FIG. 13 is a schematic configuration block diagram of a parked vehicle detection device according to a fourth embodiment;

FIG. 14 is a flowchart of the operation of the parked vehicle detection device according to the fourth embodiment;

FIG. 15 is an explanatory diagram showing an example of state transition in traveling position determination;

FIG. 16 is an operation explanatory diagram illustrating a scene that a host vehicle passes a parked vehicle while traveling in a right-side lane of a two-lane road;

FIG. 17 is an operation explanatory diagram illustrating a scene that the host vehicle passes a parked vehicle while traveling in a left-side lane of a two-lane road;

FIG. 18 is a schematic configuration block diagram of a parked vehicle detection device according to a fifth embodiment;

FIG. 19 is a flowchart of the operation of the parked vehicle detection device according to the fifth embodiment;

FIG. 20 is an explanatory diagram of the operation of the fifth embodiment;

FIG. 21 is an explanatory diagram of a first determination method for identity of a vehicle; and

FIG. 22 is an explanatory diagram of a second determination method for identity of a vehicle.

### DETAILED DESCRIPTION

According to an embodiment, a parked vehicle detection device comprises a vehicle detector, a host-vehicle position detector, a position calculator, a vehicle information storage, and a parked vehicle determiner. The vehicle detector detects another vehicle included in an image of at least a front of a host vehicle, the image captured by an imaging device mounted on the host vehicle. The host-vehicle position detector detects a position of the host vehicle. The position calculator calculates a position of the detected another vehicle based on the detected position of the host vehicle. The vehicle information storage stores therein information on the another vehicle. The information includes the calculated position. The parked vehicle determiner determines whether the another vehicle is a high possible parked vehicle based on the information on the another vehicle.

The following will describe embodiments in detail with reference to the accompanying drawings.

### 1 First Embodiment

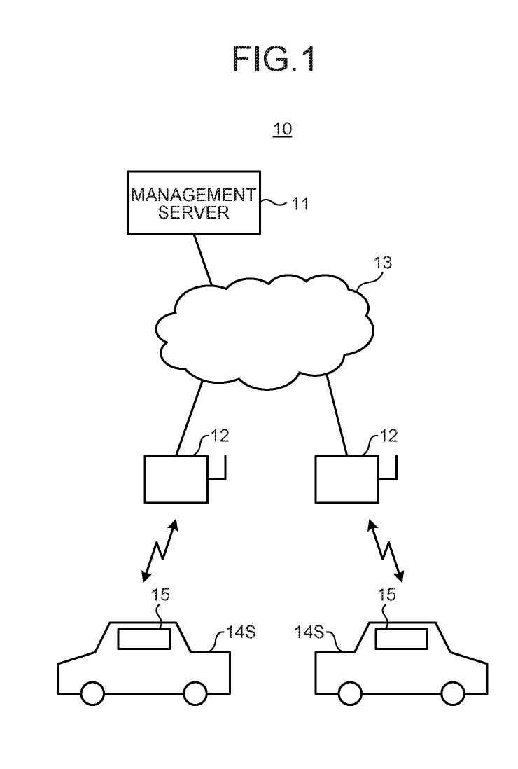

FIG. 1 is a schematic configuration block diagram of a parked vehicle detection system according to a first embodiment.

As illustrated in FIG. 1, a parked vehicle detection system 10 according to the first embodiment includes a management server 11, and a parked vehicle detection device 15 mounted on a host vehicle 14S and communicably connected to the management server 11 via a radio base station 12 and a communication network 13. In the following description, the “host vehicle 14S” signifies not only a vehicle that actually detects a parked vehicle but also a vehicle on which the parked vehicle detection device 15 is mounted.

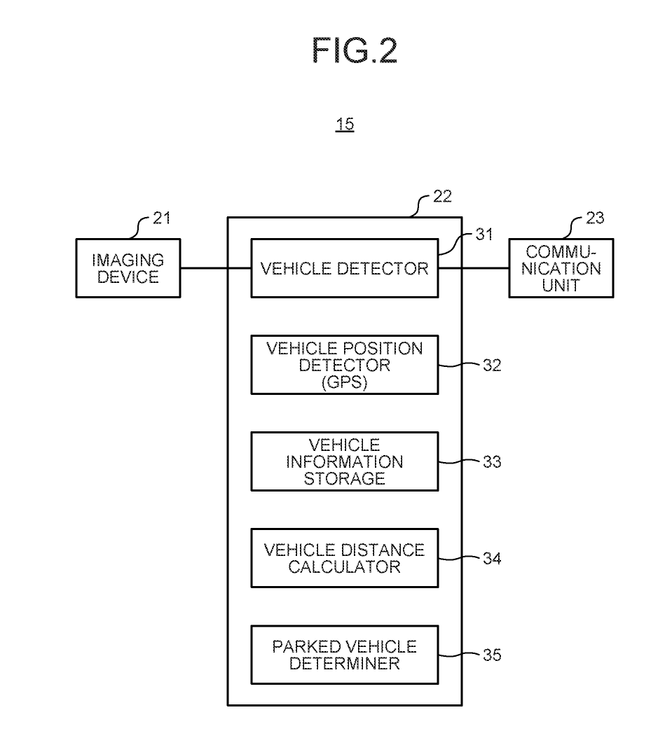

FIG. 2 is a schematic configuration block diagram of a parked vehicle detection device according to the first embodiment.

The parked vehicle detection device 15 includes an imaging device (camera) 21 that captures an image of the front of the host vehicle 14S in a traveling direction and outputs image data; a processing device 22 that detects another parked vehicle 14 according to input image data; and a communication unit 23 that transmits a result of the detection by the processing device 22 to the management server 11 as parked vehicle detection information via the radio base station 12 and the communication network 13, and receives an integrated result of different items of parked vehicle detection information from the management server 11.

The processing device 22 includes a vehicle detector 31 that detects an image corresponding to the another vehicle 14 from an image corresponding to the image data; a vehicle position detector 32 that detects the position of the host vehicle 14S on which the processing device 22 is mounted, and calculates the position of the another vehicle 14 detected by the vehicle detector 31 according to the detected position of the host vehicle 14S; a vehicle information storage 33 that stores therein vehicle information such as the position of the another vehicle 14 calculated by the vehicle position detector 32 and a detection time; a vehicle distance calculator 34 that calculates distances among other vehicles 14 according to the vehicle information on the other vehicles 14 stored in the vehicle information storage 33; and a parked vehicle determiner 35 that determines a vehicle is high possible parked vehicle according to a result of the calculation by the vehicle distance calculator 34.

In the above configuration, the management server 11 is configured to manage a road information service system, a traffic control system, an EV bus charging management system, a traffic control management system, or the like.

Next, the following will describe an operation according to the first embodiment.

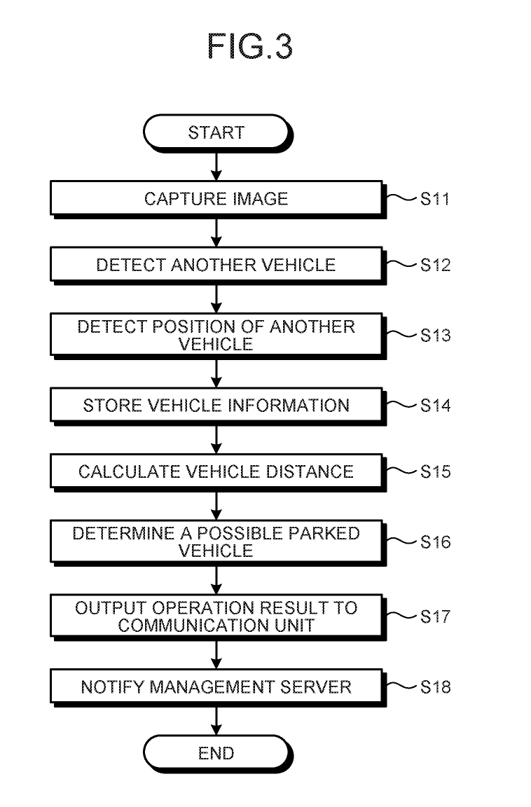

FIG. 3 is flowchart of the operation of the parked vehicle detection device according to the first embodiment.

First, the imaging device 21 captures an image of the front of the host vehicle 14S in the traveling direction and outputs image data to the processing device 22 (Step S11).

Then, the vehicle detector 31 of the processing device 22 detects an image corresponding to another vehicle 14 from an image corresponding to the image data (Step S12).

Herein, a vehicle detection technique described in “A Trainable System for Object Detection, Papageorgiou et al., IJCV-2000” is employed, for example.

In this case, typically, the parked vehicle is located on the left side of the traveling host vehicle in the case of left-hand traffic, and on the right side of the host vehicle in the case of right-hand traffic. Thus, only vehicles detected in such a position in the image can be set to targets to be calculated. Thereby, a calculation amount can be reduced.

In the first embodiment, when one item of image data includes images of a plurality of vehicles, each of the vehicles is identified. However, for the sake of operational simplification, the same vehicle (or vehicles) is not tracked across a plurality of items of image data (across a plurality of frames).

Next, the vehicle position detector 32 of the processing device 22 detects (calculates) an actual position of the another vehicle 14 from the image corresponding to the another vehicle 14 (Step S13).

Specifically, the vehicle position detector 32 detects the position of the host vehicle 14S at a timing at which the image data is captured with a GPS device (not illustrated), and corrects a distance estimated from an angle of view of the imaging device 21 to detect the position of the another vehicle 14. The host vehicle 14S can be detected from positional information on a base station of a cellular telephone, a wireless LAN access point, and a base station of a beacon in place of the GPS device.

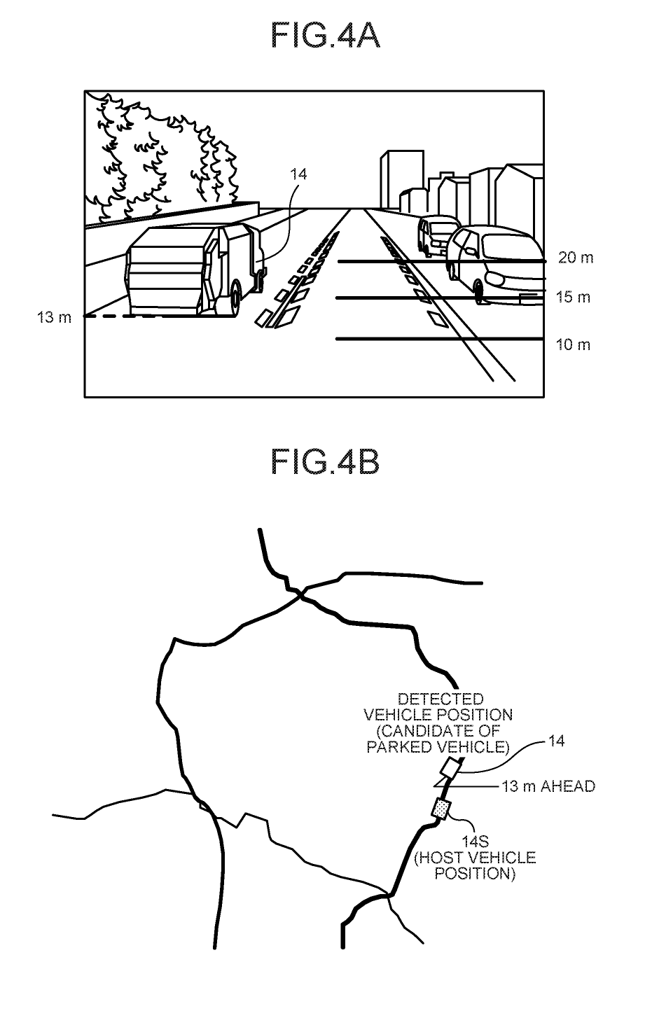

FIG. 4A is an explanatory diagram (part 1) for distance correction.

FIG. 4B is an explanatory diagram (part 2) for distance correction.

As illustrated in FIG. 4A, a distance from the host vehicle 14S can be detected in accordance with the vertical position of a vehicle rear end on a captured image. Thus, the vehicle position detector 32 detects the position of the vehicle rear end (a lower end of an image region corresponding to the vehicle in FIG. 4A), and adds a correction distance to the position of the host vehicle 14S (for example, a GPS positioning position) to obtain the position of the another vehicle 14 to be calculated. As a result, as illustrated in FIG. 4B, the another vehicle 14 is detected at a position 13 m ahead of the host vehicle 14S.

With use of a stereo camera for the imaging device 21 instead of a monocular camera, relative position information of the another vehicle 14 may be detected from distance information obtained by stereoscopic measurement.

In this case, for example, in a left-hand traffic, when the vehicle 14 is located in an upper image region of the captured image and gradually moves downward to the left, and the image region of the vehicle 14 gradually increases in size and disappears (or almost disappears) from a screen through multiple detections, it can be considered that the same vehicle 14 has been detected multiple times. Accordingly, the position of the host vehicle 14S at the time when the vehicle 14 disappears (or almost disappears) from the screen may be detected by a GPS device and the position of another vehicle 14 may be calculated by correcting the distance estimated from the angle of view of the imaging device 21. Thus, by the configuration including the vehicle tracking, it is made possible to prevent the positions of the same vehicle detected multiple times from being erroneously detected as the positions of different vehicles.

Subsequently, the vehicle information storage 33 stores therein the vehicle information such as the position of the other vehicle 14 calculated by the vehicle position detector 32 and the detection time (Step S14).

Subsequently, the vehicle distance calculator 34 calculates distances among other vehicles 14 according to the vehicle information on the other vehicles 14 stored in the vehicle information storage 33 (Step S15).

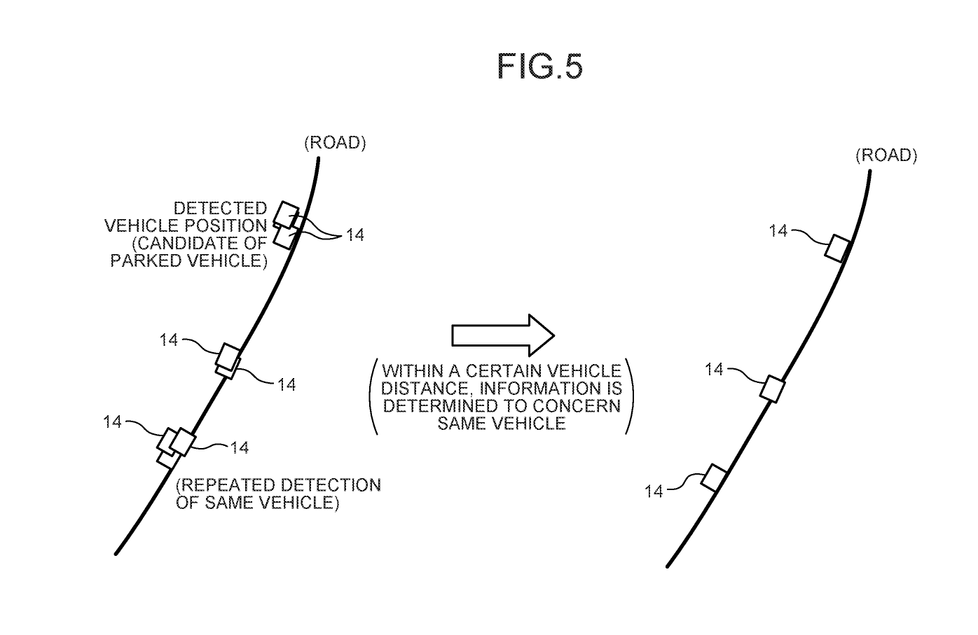

FIG. 5 is an explanatory diagram for the concept of stored vehicle information.

In Step S15, when a distance between the vehicle positions indicated by the vehicle information is equal to or smaller than a predetermined distance, the stored vehicle information is considered to correspond to the same vehicle 14, therefore, the vehicle information at any of the positions can be handled as the vehicle information on the another vehicle 14.

As a result, as illustrated in FIG. 5, even when different items of vehicle information about the same vehicle 14 are stored, the vehicle information of different vehicles 14 can be surely separated, leading to reducing a calculation load.

Subsequently, the parked vehicle determiner 35 determines a high possible parked vehicle 14 from other vehicles 14 on the basis of the distances among the other vehicles 14 that are estimated to be different vehicles 14 by the vehicle distance calculator 34 (Step S16).

For example, when the vehicle distance is equal to or larger than a constant value, the parked vehicle determiner 35 determines the vehicle 14 as a high possible parked vehicle 14. This is because in general the distances among vehicles temporarily stopping in a traffic jam tend to be small, and those among parked vehicles tend to be large. Thus, a high possible parked vehicle can be determined according to the vehicle distance.

More specifically, a target vehicle to be detected can be determined as a high possible parked vehicle 14 on the basis of a predetermined threshold Dth of the vehicle distance relative to a distance D between the target vehicle and a vehicle 14 adjacent to the target vehicle, such that the more largely a parked vehicle determination value E1 exceeds 1.0, the higher the possibility of a parked vehicle is.

Alternatively, when three or more other vehicles 14 are detected, a variance (=σ²) of vehicle distance values among the vehicles 14 may be obtained to determine the vehicles as parked vehicles when the variance is equal to or larger than a constant value. This is because the distances among temporarily stopping vehicles in a traffic jam typically tend to be similar values, and the vehicle distances among the high possible parked vehicles tend to be variously different. Thus, from the variance of the vehicle distances taking the constant value or larger, the vehicles 14 can be estimated to be highly possible parked vehicles.

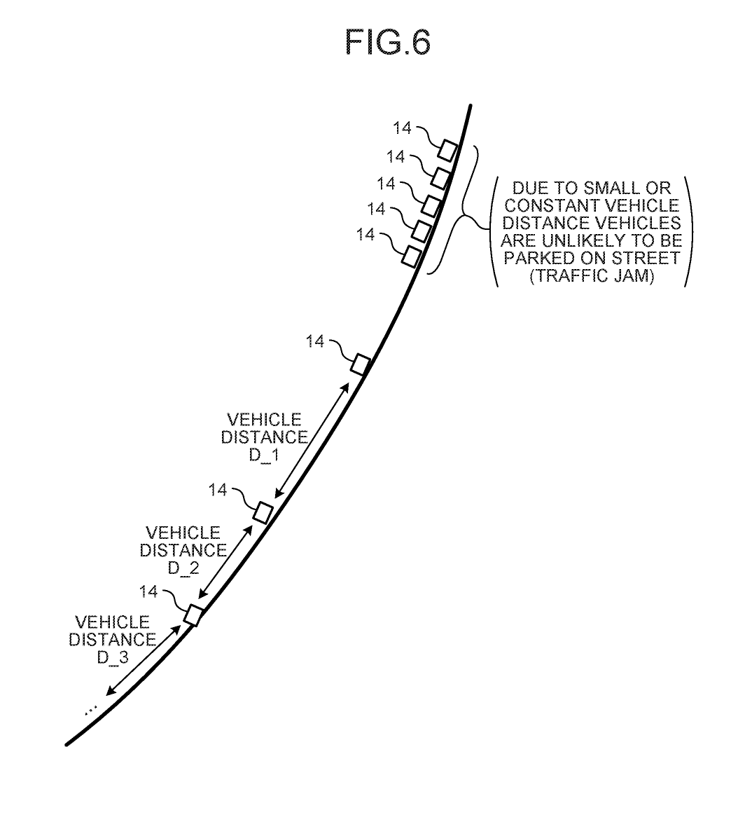

FIG. 6 is an explanatory diagram for determination of the parked vehicle from the variance of the vehicle distances.

As illustrated in an upper part of FIG. 6, typically, the vehicle distances among the temporarily stopping vehicles in a traffic jam tend to be similar to each other, and those among parked vehicles tend to be largely different as illustrated in a lower part of FIG. 6. Therefore, the vehicles 14 can be determined to be high possible parked vehicles or not from the variance of the vehicle distances.

Specifically, as illustrated in the lower part of FIG. 6, for example, a variance value V is represented by the following expression:

V=(1/4)·Σ(D_i−Dave)

where D_i (i=1 to 4) represents the distances of five adjacent vehicles and Dave represents an average thereof.

Thus, the target vehicle 14 to be detected can be determined as a high possible parked vehicle according to a predetermined threshold Vth of the variance value V, such that the more largely a parked vehicle determination value E2=V/Vth exceeds 1.0, the higher the possibility of a parked vehicle is.

As described above, the vehicles 14 estimated to be high possible parked vehicles can be detected by calculating the positions of the other vehicles 14 and the distances among the vehicle positions from the captured image by the imaging device 21 mounted on the host vehicle 14S.

Accordingly, the parked vehicle detection device 15 according to the first embodiment does not need to read a number plate, that is, can automatically determine whether the detected vehicle 14 is a high possible parked vehicle 14 if it fails to read the number plate. Further, the parked vehicle detection device 15 according to the first embodiment can be mounted on the vehicle 14, so that it does not require an operator or the installation of a fixed camera to detect the high possible parked vehicle 14, which can reduce installation costs.

Subsequently, the processing device 22 outputs a result of the operation to the communication unit 23 as vehicle information (information for parked vehicle detection) (Step S17).

Thereby, the communication unit 23 notifies the management server 11 of the vehicle information as the result of the operation, that is, parked vehicle information, via the radio base station 12 and the communication network 13 (Step S18).

When receiving, in a certain period of time, the parked vehicle information on vehicles 14 detected at the same position (the positions that can be regarded as the same position considering an error) by a plurality of vehicles 14, the management server 11 processes the vehicle, determining that the vehicle is parked at that position.

For example, when there are a certain number (for example, five) or more of host vehicles 14S that have transmitted the parked vehicle information at the same position, the management server 11 determines that a different vehicle 14 from the host vehicles 14S is parked at the position corresponding to the parked vehicle information. When the number of host vehicles 14S that have transmitted the parked vehicle information is smaller than the certain number (for example, five), the management server 11 determines that the vehicle 14 is not parked at the position corresponding to the parked vehicle information (so-called erroneous detection).

More specifically, for example, when only two host vehicles 14S transmit the parked vehicle information in the certain period of time, the management server 11 discards the parked vehicle information, determining that the vehicle 14 is not parked at the position. When eight host vehicles 14S transmit the parked vehicle information in the certain period of time, the management server 11 determines that one vehicle 14 is parked at the position, integrates the parked vehicle information, and processes the one parked vehicle 14.

As a result, through the above operations, the parked vehicle information on the host vehicles 14S is notified to the management server 11 of a road information providing system, a traffic control system, an EV bus charging management system, or a traffic control management system and can be utilized for providing or predicting information.

For example, when included in the road information service system, the management server 11 can plot parked vehicles on a map on the basis of the parked vehicle information, and provide the map as on-street parking map information.

When included in the traffic control system, on-street parking is a hindrance for a traffic flow, so that the management server 11 can simulate a traffic condition that only one lane of a two-lane road is actually available, or a traffic condition that the occurrence of a traffic jam becomes more probable than usual. As a result, the traffic control system can improve the accuracy for the estimation or prediction of a road condition.

When included in the EV bus charging management system, as included in the traffic control system, the management server 11 can manage charging of an EV bus to prevent power deficiency (running out of electric power) by charging for a longer time to control a charge amount to increase if a traffic jam is expected in a bus route ahead from an estimated or predicted road condition.

When included in the traffic control management system, the management server 11 can determine a priority area for controls over parking violation and the like on the basis of the parked vehicle information and predicted traffic information.

As described above, according to the first embodiment, each of parked vehicle detection devices 15 mounted on a plurality of host vehicles 14S can detect high possible parked vehicles 14. Further, according to the first embodiment, the management server 11 integrates the vehicle information on the detected high possible parked vehicles 14 to specify the parking positions (detected positions), to thereby able to more accurately estimate or predict a road condition with a simple configuration.

### 2 Second Embodiment

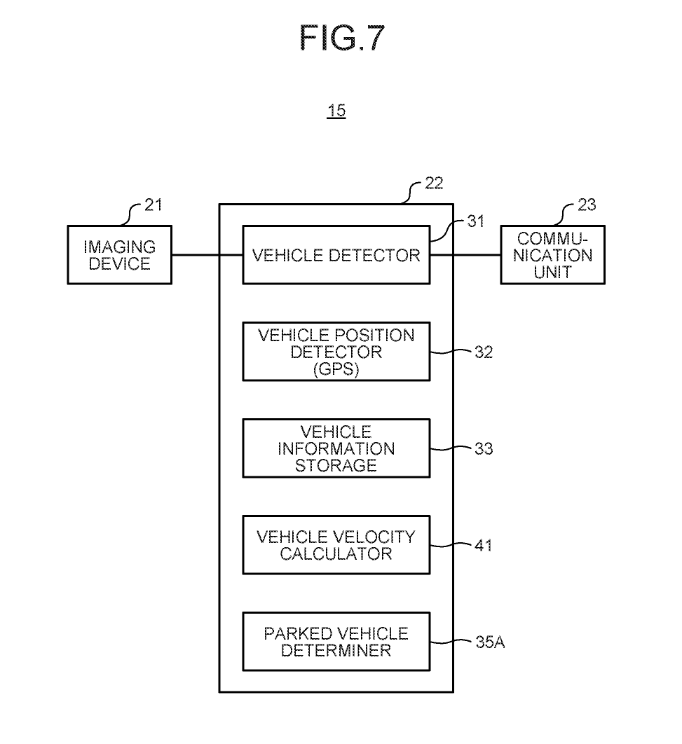

FIG. 7 is a schematic configuration block diagram of the parked vehicle detection device according to a second embodiment.

The parked vehicle detection device in FIG. 7 is different from that in the first embodiment in FIG. 2 in that the processing device 22 includes, in place of the vehicle distance calculator 34, a vehicle velocity calculator 41 that calculates velocities (absolute velocities) of the host vehicle 14S and another vehicle 14 to be detected, and includes, in place of the parked vehicle determiner 35, a parked vehicle determiner 35A that determines whether another vehicle is a parked vehicle according to the velocity of the another vehicle 14 calculated by the vehicle velocity calculator 41.

The following will describe an operation according to the second embodiment.

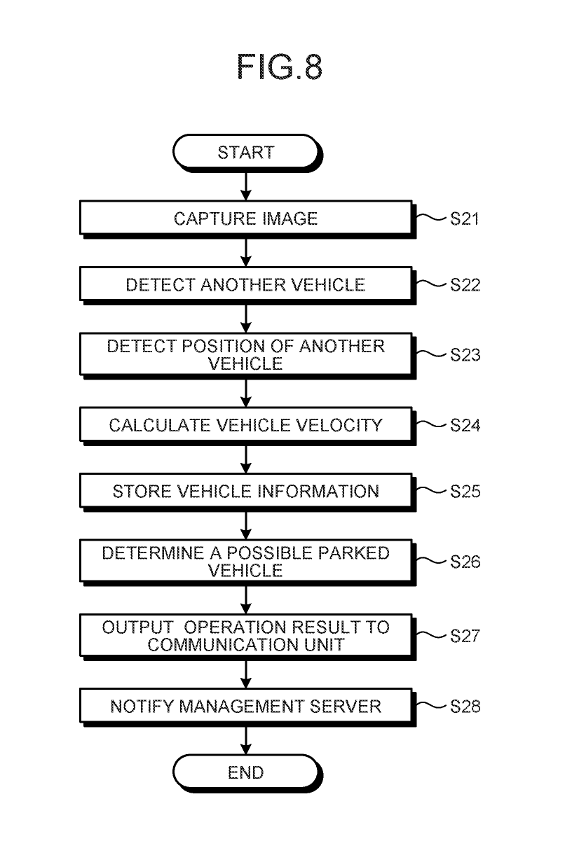

FIG. 8 is a flowchart of the operation of the parked vehicle detection device according to the second embodiment.

First, the imaging device 21 captures an image of the front of the vehicle 14 in the traveling direction and outputs image data to the processing device 22 (Step S21).

Thus, the vehicle detector 31 of the processing device 22 detects an image corresponding to another vehicle 14 from an image corresponding to the image data, as in the first embodiment (Step S22).

Next, the vehicle position detector 32 of the processing device 22 calculates an actual position of another vehicle 14 from the image corresponding to the another vehicle 14, as in the first embodiment (Step S23).

Subsequently, the vehicle velocity calculator 41 of the processing device 22 calculates the velocities of the host vehicle 14S and the another vehicle 14 to be detected (Step S24).

An absolute velocity VSA of the host vehicle can be obtained from a vehicle body via a controller area network (CAN), for example.

A relative velocity VTR of the detected another vehicle 14 can be calculated by the following expression:

VTR=(D_B−D_A)/T

where A and B represent images captured at a certain time interval T and D_A and D_B represent distances between the host vehicle and the detected vehicle in the images A, B, respectively.

In this case, for example, the distance D_A and the distance D_B are calculated by the method illustrated in FIG. 4A and FIG. 4B.

Typically, at a sufficiently small time interval T, it is unlikely to erroneously measure the relative velocities of different vehicles 14 in the distances D_A and D_B. That is, it is unlikely to determine different vehicles 14 as a target vehicle 14 in the distance D_A and distance D_B.

In this case, by tracking the vehicles as described in “Tracking of Multiple, Partially Occluded Humans based on Static Body Part Detection”, Bo Wu et al., CVPR-2006, it is able to prevent a wrong vehicle from being mistakenly identified for the target vehicle.

Based on the values obtained as described above, an absolute velocity VTA of the another vehicle 14 as the target can be calculated by the following expression:

VTA=VSA+VTR

Subsequently, the vehicle information storage 33 stores therein the vehicle information such as the position of the another vehicle 14 calculated by the vehicle position detector 32, the absolute velocity VTA, and the detection time (Step S25).

Next, the parked vehicle determiner 35A determines a high possible parked vehicle according to a predetermined velocity threshold Vth (for example, 5 km/hr) with respect to the absolute velocity VTA of the detected target vehicle 14 calculated by the vehicle velocity calculator 41, such that the more largely a parked vehicle determination value EB=Vth/VTA exceeds 1.0, the closer to zero (stop)the velocity is, and the higher the possibility of a parked vehicle is (Step S26).

Such an operation can prevent a vehicle 14 not stopping but traveling at a low speed from being erroneously determined to be a parked vehicle.

Subsequently, the processing device 22 outputs a result of the operation to the communication unit 23 as the vehicle information (information for parked vehicle information) (Step S27).

Thereby, the communication unit 23 notifies the management server 11 of the vehicle information as the operation result, that is, the parked vehicle information, via the radio base station 12 and the communication network 13 (Step S28).

As described above, according to the second embodiment, since each of the parked vehicle detection devices 15 mounted on the vehicles 14 obtains the absolute velocity of the detected target vehicle 14 for the estimation of the high possible parked vehicle 14 in addition to the effects of the first embodiment, it can more surely estimate the high possible parked vehicle 14.

### 3 Third Embodiment

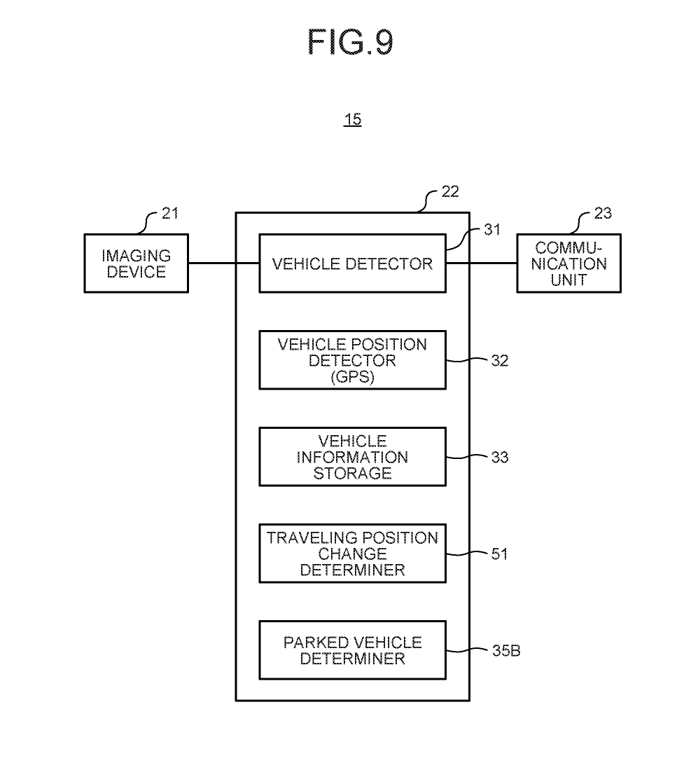

FIG. 9 is a schematic configuration block diagram of the parked vehicle detection device according to a third embodiment.

The parked vehicle detection device in FIG. 9 is different from that in the first embodiment in FIG. 2 in that the processing device 22 includes, in place of the vehicle distance calculator 34, a traveling-position change determiner 51 that determines whether there is a change in a traveling position (lane position) of the host vehicle 14S, and includes, in place of the parked vehicle determiner 35, a parked vehicle determiner 35B that determines whether another vehicle 14 is a parked vehicle according to a result of the determination by the traveling-position change determiner 51.

The following will describe an operation according to the third embodiment.

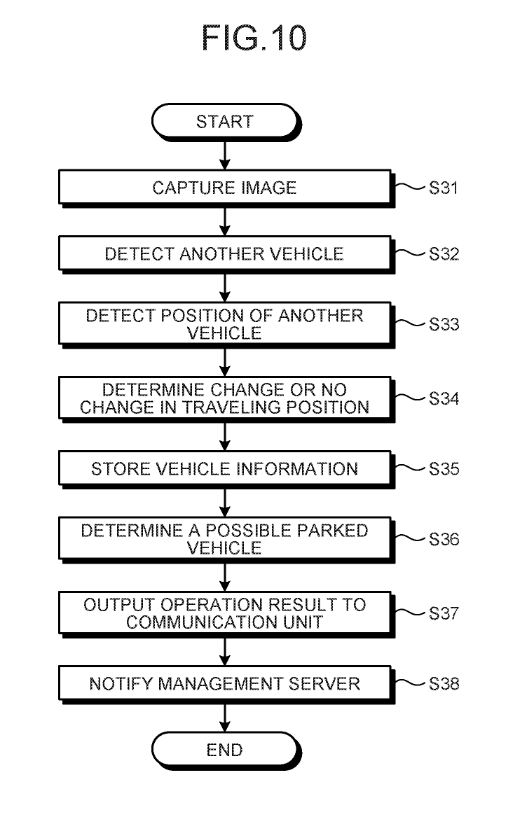

FIG. 10 is a flowchart of the operation of the parked vehicle detection device according to the third embodiment.

First, the imaging device 21 captures an image of the front of the vehicle 14 in the traveling direction and outputs image data to the processing device 22 (Step S31).

Thus, the vehicle detector 31 of the processing device 22 detects an image corresponding to another vehicle 14 from an image corresponding to the image data, as in the first embodiment (Step S32).

Next, the vehicle position detector 32 of the processing device 22 calculates an actual position of the another vehicle 14 from the image corresponding to the another vehicle 14, as in the first embodiment (Step S33).

Subsequently, the traveling-position change determiner 51 of the processing device 22 acquires the amount of a movement or an operation (hereinafter, collectively referred to as movement and operation amount M) of the host vehicle 14S, and determines whether there is a change in the traveling position (lane position) of the host vehicle 14S (Step S34).

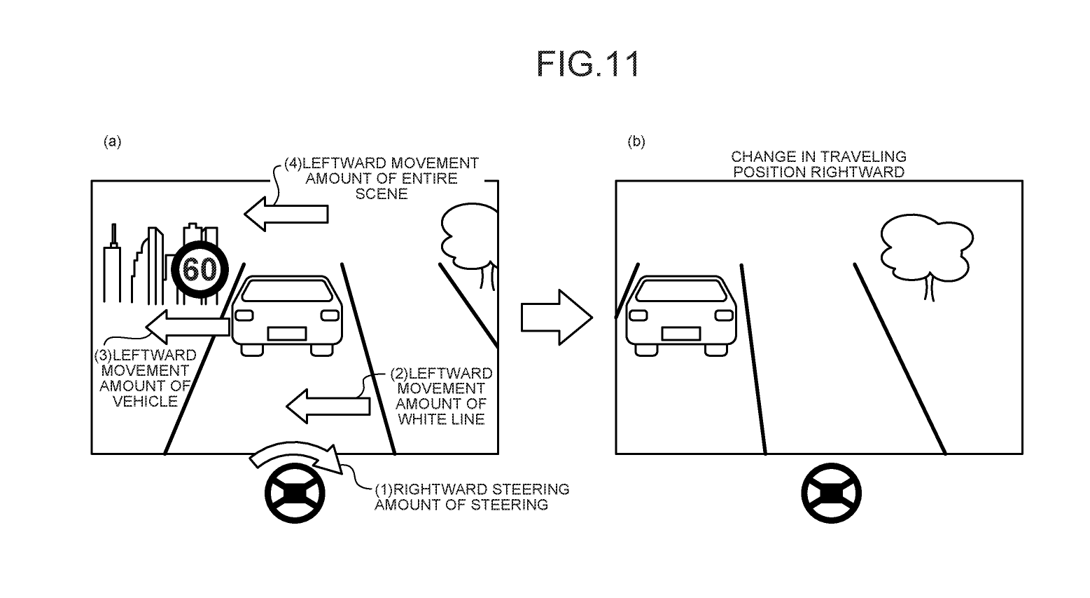

FIG. 11 is an explanatory diagram for the determination of a change in the traveling position from a steering amount.

A change or no change in the traveling position is determined, for example, according to steering information, that is, whether the vehicle is operated at a predetermined amount or more to right and left with steering, as indicated by a reference sign (1) in the left part (a) of FIG. 11.

More specifically, for example, when a rightward steering amount of the steering exceeds a predetermined operation amount (a standard operation amount or a threshold operation amount), the traveling-position change determiner 51 determines that the vehicle has changed the traveling position rightward.

Instead of the steering amount, as indicated by the reference sign (2) in the left part (a) of FIG. 11, the determination may be made by detecting a lane line (right and left white lines indicating a traveling area) from the image captured by the imaging device 21 and determining whether the position thereof is moved to right or left. A traffic lane markings (white lines) detecting method described, for example, in “Video Based Lane Estimation and Tracking for Driver Assistance: Survey, System, and Evaluation”, Joel C. McCall et al., IEEE Transactions on ITS, March 2006 may be adopted.

As indicated by the reference sign (3) in the left part (a) of FIG. 11, determination can also be made according to the position of the another vehicle 14 detected by the vehicle detector 23. For example, when the detected vehicle 14 moves the position from the center area to the left area, it can be determined that the host vehicle 14S has likely changed the traveling position rightward. Alternatively, as indicated by the reference sign (4) in the left part (a) of FIG. 11, upon detection of the leftward movement (flow) of the entire image on the screen, it can be determined that the host vehicle 14S has likely changed the traveling position rightward as illustrated in the right part (b) of FIG. 11.

Subsequently, the vehicle information storage 33 stores therein the vehicle information such as the position of the another vehicle 14 calculated by the vehicle position detector 32, the detection time, and a time at which the traveling position has changed (Step S35).

As for the time at which the traveling position has changed, only a time at which the vehicle has made a lane change to right during traveling on a left lane may be stored.

Next, the parked vehicle determiner 35B determines, as a high possible parked vehicle, the vehicle 14 detected around the time at which the traveling-position change determiner 51 determines a change in the traveling position (Step S36).

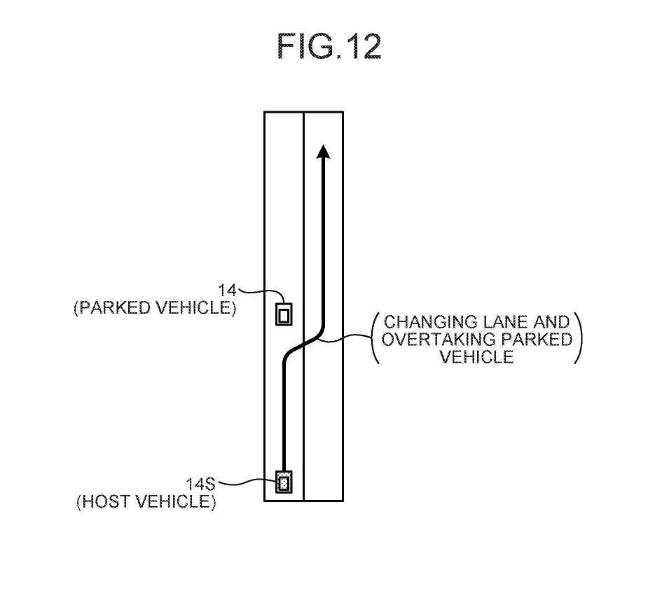

FIG. 12 is an explanatory diagram for overtaking the parked vehicle.

Herein, the term, “overtake” is used in a general sense and does not signify overtaking a running vehicle under the road traffic law.

As illustrated in FIG. 12, when the parked vehicle 14 is located ahead of the host vehicle 14S traveling in a left lane, the host vehicle 14S is likely to change the lane to avoid the parked vehicle.

Thus, the parked vehicle determiner 35B determines, as a high possible parked vehicle, another vehicle 14 detected when the host vehicle 14S changes the lane for overtake.

Specifically, based on a threshold Mth of the movement and operation amount with respect to the movement and operation amount M obtained at Step S34, a high possible parked vehicle can be determined, such that the more largely a parked vehicle determination value EC (=M/Mth) exceeds 1.0, the higher the possibility of a parked vehicle is. Through such processing, the high possible parked vehicle 14 can be determined more accurately.

Subsequently, the processing device 22 outputs a result of the operation to the communication unit 23 (Step S37).

Thus, the communication unit 23 notifies the management server 11 of the vehicle information as the operation result, that is, the parked vehicle information, via the radio base station 12 and the communication network 13 (Step S38).

Thereby, when receiving the parked vehicle information on the vehicles 14 detected at the same position (the positions that can be regarded as the same position considering an error) by the vehicles 14 in the certain period of time, the management server 11 determines that the vehicle 14 is being parked at the position and performs the operations as in the first embodiment.

As described above, according to the third embodiment, each of the parked vehicle detection devices 15 mounted on the vehicles obtains the absolute velocity of another vehicle 14 as a target for detecting a high possible parked vehicle 14 in addition to the effects of the first embodiment, so that it can estimate the parked vehicle more surely.

### 4 Fourth Embodiment

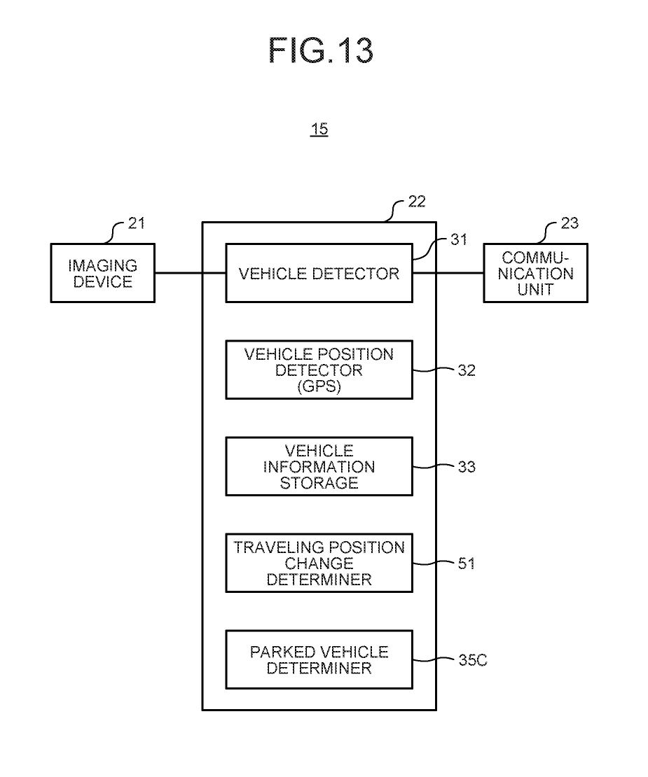

FIG. 13 is a schematic configuration block diagram of the parked vehicle detection device according to a fourth embodiment.

The parked vehicle detection device in FIG. 13 is different from that in the first embodiment in FIG. 2 in that the processing device 22 includes, in place of the vehicle distance calculator 34, the traveling position-change determiner 51 that determines a change or no change in the traveling position (lane position) of the host vehicle 14S, and includes, in place of the parked vehicle determiner 35, a parked vehicle determiner 35C that determines whether another vehicle 14 is a parked vehicle according to the movement of the host vehicle 14S and state transition of a detected vehicle.

The following will describe an operation according to the fourth embodiment.

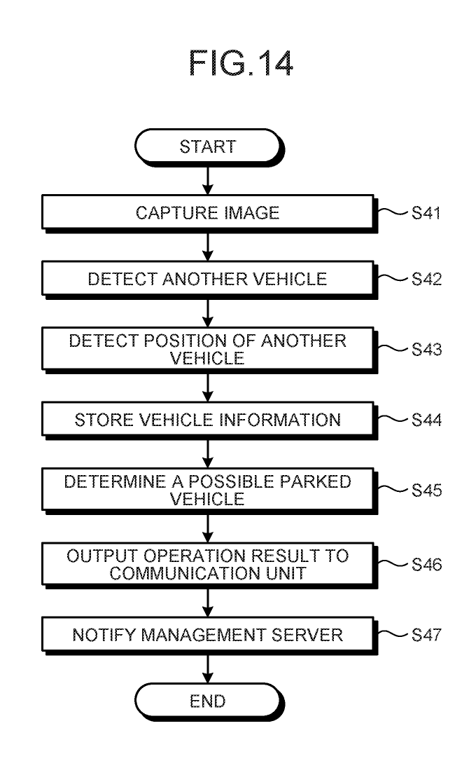

FIG. 14 is a flowchart of the operation of the parked vehicle detection device according to the fourth embodiment.

First, the imaging device 21 captures an image of the front of the host vehicle 14S in the traveling direction and outputs image data to the processing device 22 (Step S41).

Thus, the vehicle detector 31 of the processing device 22 detects an image corresponding to the another vehicle 14 from an image corresponding to the image data as in the first embodiment (Step S42).

Next, the vehicle position detector 32 of the processing device 22 calculates an actual position of the another vehicle 14 from the image corresponding to the another vehicle 14 as in the first embodiment (Step S43).

Subsequently, the vehicle information storage 33 stores therein the vehicle information such as the position of the another vehicle 14 calculated by the vehicle position detector 32 and the detection time (Step S44).

The parked vehicle determiner 35C of the processing device 22 then determines presence or absence of a high possible parked vehicle 14 according to the movement of the host vehicle 14S and the state transition of the detected vehicle (Step S45).

Subsequently, the processing device 22 outputs a result of the operation to the communication unit 23 (Step S46).

Thus, the communication unit 23 notifies the management server 11 of the vehicle information as the operation result, that is, the parked vehicle information, via the radio base station 12 and the communication network 13 (Step S47).

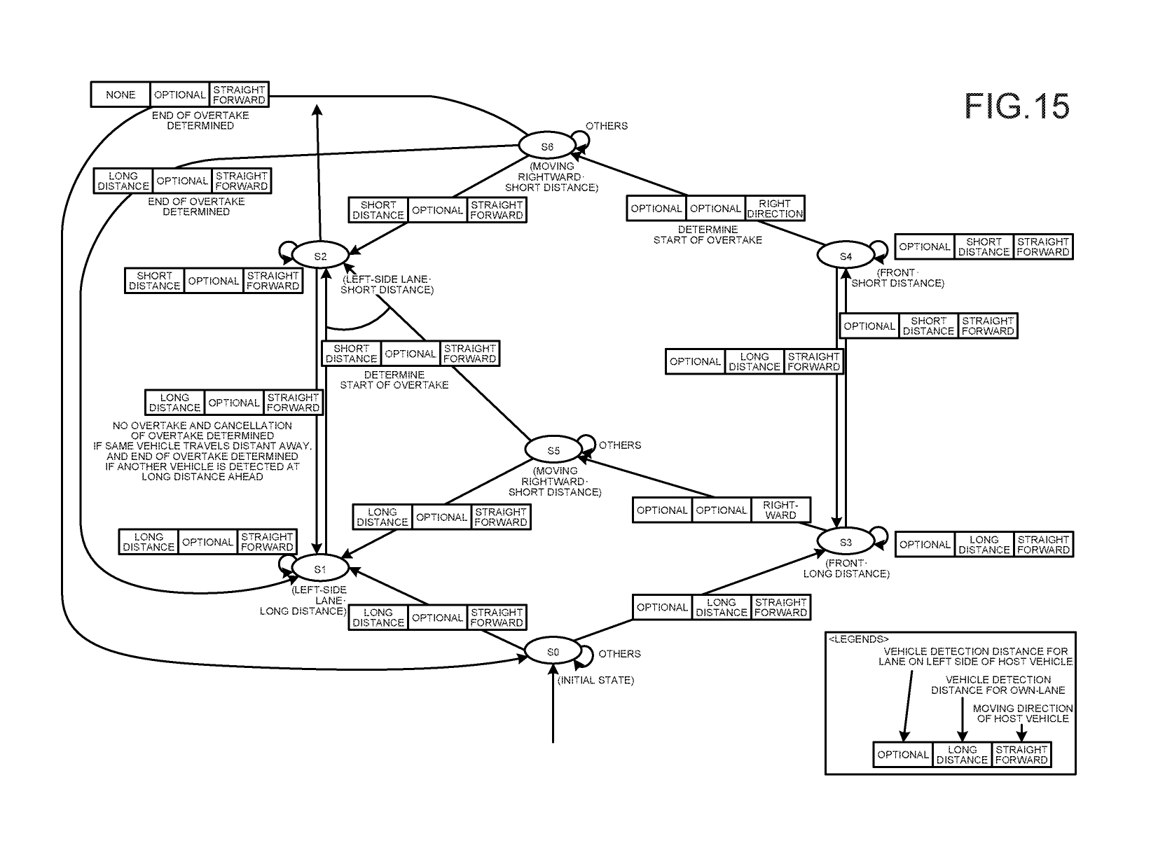

FIG. 15 is an explanatory diagram of an example of state transition in the traveling position determination.

In FIG. 15, on the premise of left-side traffic a state in which the high possible parked vehicle 14 is not detected yet is defined to be an initial state S0.

In the initial state S0, when the host vehicle 14S drives straight forward (not in the strict sense and including a situation regarded as driving straight forward) and another vehicle 14 is detected at a long distance in the left-side lane, that is, on the left side of an own lane in which the host vehicle 14S is traveling, the state is shifted to a state S1 in which another vehicle 14 is detected at a long distance in the left-side lane irrespective of a condition of the own lane. When the host vehicle is in the leftmost lane, that is, when there is no lane on the left side according to the road traffic law, the left-side lane is defined to include a position corresponding to a left lateral of the lane.

In the state S1, when the host vehicle 14S drives straight forward and the another vehicle 14 is continuously detected at a long distance in the left-side lane, the state S1 continues.

In the state S1, when the host vehicle 14S drives straight forward and another vehicle 14 is detected at a short distance in the left-side lane, the state is shifted to a state S2 in which another vehicle 14 is located at a short distance in the left-side lane. Upon detection of the state transition from the state S1 to the state S2, a start of overtake is determined.

In the state S2, when the host vehicle 14S drives straight forward and the another vehicle 14 is continuously detected at a short distance in the left-side lane, the state S2 continues.

In the state S2, when the host vehicle 14S drives straight forward and the same vehicle as the another vehicle 14 detected at a short distance is now detected at a long distance, the state is shifted to the state S1 again, and no overtake is occurring, so that the overtake is canceled.

In the state S2, when the host vehicle 14S drives straight forward, the another vehicle 14 detected at a short distance is no longer detected, and still another vehicle 14 is detected in the left-side lane, completion of the overtake is determined and the state is shifted to the state S1.

In the state S2, when the host vehicle 14S drives straight forward (continuance of the straight forward driving) and the another vehicle 14 is no longer detected in the left-side lane, completion of the overtake is determined and the state is shifted to the state S0.

In the initial state S0, when the host vehicle 14S drives straight forward and another vehicle 14 is detected at a long distance in the own lane, the state is shifted to a state S3 in which another vehicle 14 is detected at a long distance in the own-vehicle lane irrespective of a condition of the left-side lane.

In the state S3, when the host vehicle 14S drives straight forward, and the another vehicle 14 is continuously detected at a long distance in the own lane, the state S3 continues.

In the state S3, when the host vehicle 14S drives straight forward and another vehicle 14 is detected at a short distance in the own-vehicle lane, the state is shifted to a state S4 in which another vehicle 14 is located at a short distance in the own lane.

In the state S4, when the host vehicle 14S drives straight forward, and the another vehicle 14 is continuously detected at a short distance in the own lane, the state S4 continues.

In the state S4, when the host vehicle 14S drives straight forward and the same vehicle as the another vehicle 14 detected at a short distance is now detected at a long distance, the state is shifted to the state S3 again, no overtake is occurring, therefore, the overtake is canceled.

In the state S4, upon detection of a rightward driving of the host vehicle 14S, a start of overtake is determined irrespective of conditions of the left-side lane and the own lane, and the state is shifted to a state S6 in which the host vehicle 14S is driving rightward (changing a route to the right-side lane, for example) and another vehicle 14 is located at a short distance. When the host vehicle is in the rightmost lane, that is, when there is no lane on the right side according to the road traffic law, the right-side lane includes a position corresponding to a right lateral of the lane.

In the state S3, upon detection of a rightward driving of the host vehicle 14S, the state is shifted to the state S5 that the host vehicle 14S is driving rightward (changing the route to the right-side lane) irrespective of conditions of the left-side lane and the own lane.

In the state S5, when the host vehicle 14S drives straight forward and another vehicle 14 is detected at a short distance in the left-side lane, the state is shifted to the state S2 in which another vehicle 14 is located at a short distance in the left-side lane. If the transition from the state S5 to the state S2 is detected, a start of overtake is determined.

In the state S5, when the host vehicle 14S drives straight forward and another vehicle 14 is detected at a long distance in the left-side lane, the state is shifted to the state S1 in which another vehicle 14 is detected at a long distance in the left-side traffic lane irrespective of a condition of the own lane.

In the state S5, in the other situations than the above, that is, neither that the host vehicle 14S drives straight forward and another vehicle 14 is detected at a short distance in the left-side lane, nor that the host vehicle 14S drives straight forward and another vehicle 14 is detected at a long distance in the left-side lane, the state S5 continues (maintained).

In the state S6, when the host vehicle 14S now drives straight forward and the another vehicle 14 is no longer detected in the left-side lane, completion of the overtake is determined and the state is shifted to the state S0.

In the state S6, when the host vehicle 14S now drives straight forward and the another vehicle 14 is detected at a long distance in the left-side lane, completion of the overtake is determined and the state is shifted to the state S1.

In the state S6, when the host vehicle 14S now drives straight forward and the another vehicle 14 is detected at a short distance in the left-side lane, a start of overtake is determined and the state is shifted to the state S2.

The following will describe the operation according to the fourth embodiment in more detail.

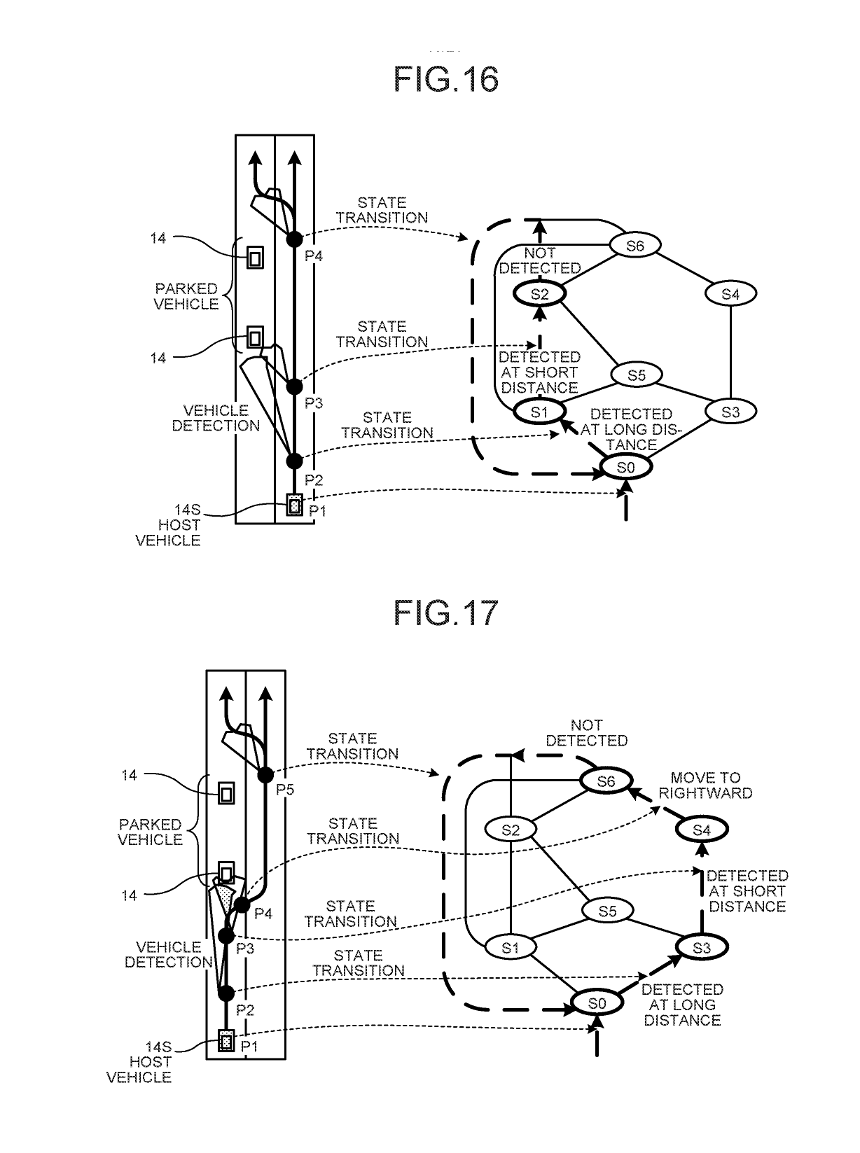

FIG. 16 is an explanatory diagram of the operation in which traveling in the right-side lane, the host vehicle passes a parked vehicle in the left-side lane of a two-lane road.

In this case, at a position P1, the host vehicle 14S is assumed to be in the initial state S0 in which no possible parked vehicle 14 has been detected yet.

Thereafter, the host vehicle 14S moves to a position P2 and drives straight forward, and another vehicle 14 is detected at a long distance in the lane on the left side of the own lane in which the host vehicle 14S is traveling, so that the state is shifted to the state S1.

Further, the host vehicle 14S moves to a position P3 and drives straight forward, and another vehicle is detected at a short distance in the lane on the left side of the own lane in which the host vehicle 14S is traveling, so that the parked vehicle determiner 35C determines a start of overtake and shifts the state to the state S2.

The host vehicle 14S moves to a position P4 and 14S drives straight forward (continuance of straight forward driving), and the another vehicle 14 is no longer detected in the lane on the left side of the own-lane in which the host vehicle 14S is traveling, so that the parked vehicle determiner 35C determines completion of the overtake and shifts the state to the state S0.

FIG. 17 is an explanatory diagram of the operation in which while traveling in the left-side lane of a two-lane road, the host vehicle moves to the right-side lane to pass a parked vehicle in the left-side lane.

In this case, at a position P1, the host vehicle 14S is assumed to be in the initial state S0 in which no possible parked vehicle 14 has been detected yet.

Thereafter, the host vehicle 14S moves to a position P2 and drives straight forward, and another vehicle 14 is detected at a long distance (ahead) in the own lane, so that the state is shifted to the state S3.

The host vehicle 14S moves to a position P3 and drives straight forward and another vehicle 14 is detected at a short distance in the own lane, so that the state is shifted to the state S4.

The host vehicle 14S moves to a position P4, a driver of the host vehicle 14S turns a steering wheel, and a rightward driving of the host vehicle 14S is detected, so that a start of overtake is determined irrespective of conditions of the left-side lane and the own lane, and the state is shifted to the state S6.

Thereafter, the host vehicle 14S moves to a position P5 and now drives straight forward and the another vehicle 14 is no longer detected, so that completion of the overtake is determined and the state is shifted to the state S0, irrespective of the situation that the host vehicle 14S keeps driving on the right side of the two lanes or returns to the left-side lane.

As described above, it is possible to determine an event that while traveling in the left-side lane, the host vehicle 14S changes the lane to the right-side lane to pass a parked vehicle 14 in the left-side lane. Thus, when the overtake of the vehicle in the left-side lane is determined, a parked vehicle determination value ED is set to 1.0 and in the other situations, the value ED is set to 0.0.

As described above, according to the fourth embodiment, it is made possible to surely and easily determine whether another vehicle 14 is a parked vehicle according to the result of the determination by the traveling-position change determiner 51 in addition to the effects of the first embodiment.

### 5 Fifth Embodiment

A fifth embodiment will describe detection of a parked vehicle 14 when the host vehicle is a route bus which drives the same route multiple times, for example.

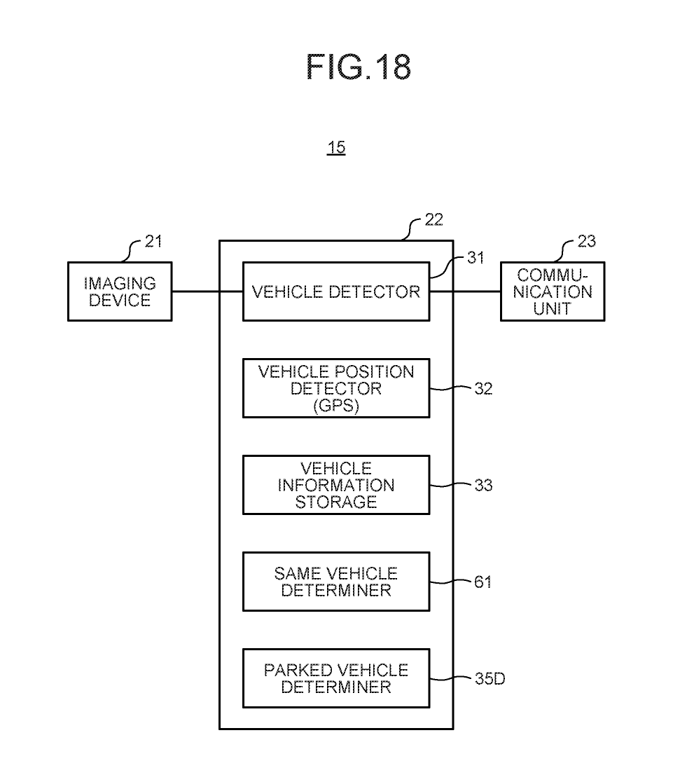

FIG. 18 is a schematic configuration block diagram of a parked vehicle detection device according to the fifth embodiment.

The parked vehicle detection device in FIG. 18 is different from that in the first embodiment in FIG. 2 in that the processing device 22 includes, in place of the vehicle distance calculator 34, a same vehicle determiner 61 that determines whether high possible parked vehicles 14 are the same vehicle, and includes, in place of the parked vehicle determiner 35, a parked vehicle determiner 35D that determines whether another vehicle 14 is a parked vehicle according to a result of the determination by the same vehicle determiner 61.

The following will describe an operation according to the fifth embodiment.

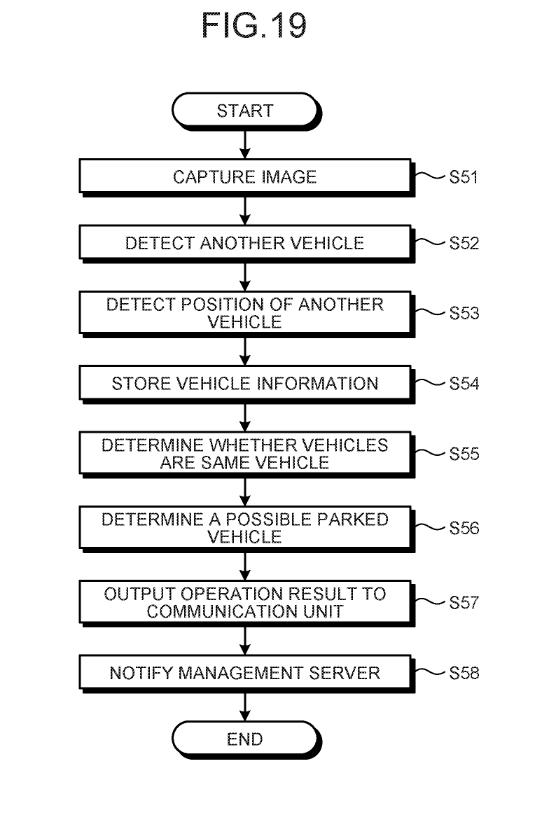

FIG. 19 is an operation processing flowchart of the parked vehicle detection device according to the fifth embodiment.

First, the imaging device 21 captures an image of the front of the host vehicle 14S in the traveling direction of and outputs image data to the processing device 22 (Step S51).

Thus, the vehicle detector 31 of the processing device 22 detects an image corresponding to another vehicle 14 from an image corresponding to the image data, as in the first embodiment (Step S52).

Next, the vehicle position detector 32 of the processing device 22 calculates an actual position of the another vehicle from the image corresponding to the another vehicle 14, as in the first embodiment (Step S53).

Subsequently, the vehicle information storage 33 stores therein the vehicle information such as the position of the another vehicle 14 calculated by the vehicle position detector 32 and the detection time (Step S54).

Next, the same vehicle determiner 61 determines whether a plurality of items of vehicle information acquired at sufficiently close positions concern the same vehicle (Step S55).

Subsequently, the parked vehicle determiner 35D determines a high possible parked vehicle 14 from other vehicles 14 according to vehicle distances among the other vehicles 14 estimated to be different vehicles 14 output from the vehicle distance calculator 34 (Step S56).

Then, the processing device 22 outputs a result of the operation to the communication unit 23 (Step S57).

Thereby, the communication unit 23 notifies the management server 11 of the vehicle information as the operation result, that is, the parked vehicle, via the radio base station 12 and the communication network 13 (Step S58).

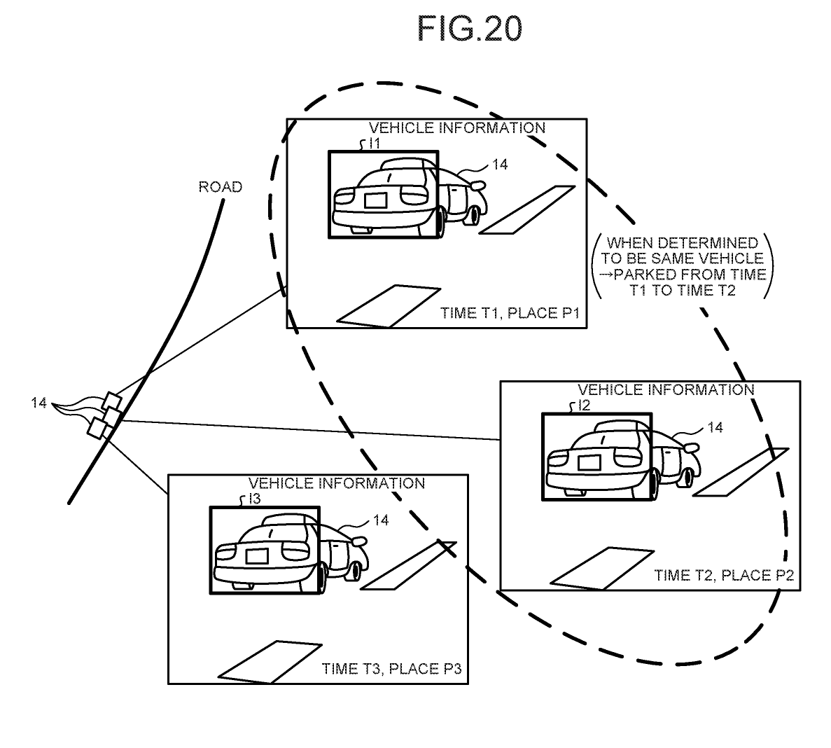

FIG. 20 is an explanatory diagram of the operation according to the fifth embodiment.

As illustrated in FIG. 20, when items of vehicle information I1, I2, and I3 are collected at different times T1, T2, and T3 and the vehicle information I1 and the vehicle information I2 are determined to be information concerning the same vehicle, for example, it can be determined that the vehicle has been parked for a period from the time T1 to the time T2.

In this case, vehicle identity may be determined, for example, by at least one of the following three methods.

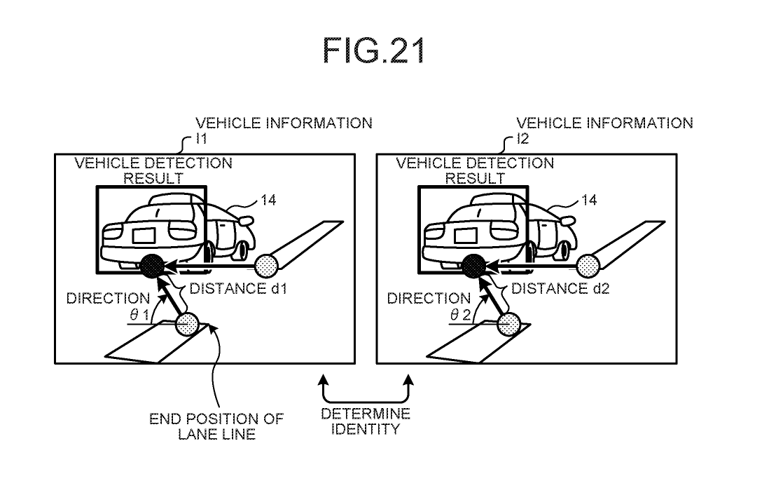

FIG. 21 is an explanatory diagram for a first vehicle identity determination method.

According to the first method, as illustrated in FIG. 21, the same vehicle determiner 61 first detects the end position of a lane line (such as a white line). The lane markings may be detected by a method, for example, described in “Video Based Lane Estimation and Tracking for Driver Assistance: Survey, System, and Evaluation”, Joel C. McCall et al., IEEE Transactions on ITS, March 2006. By detecting a corner in an area of the detected lane, the end position can be detected.

Next, relative position information on the end position of the lane line and the vehicle position is calculated.

Specifically, a distance d (=d1 or d2) and a direction θ (=θ1 or θ2) illustrated in FIG. 21 are calculated. If values of the calculated distance d and direction θ of the items of vehicle information are sufficiently close to each other, that is, a high similarity among the values is found, the vehicles can be determined to be the same vehicle (parked vehicle) continuously stopping at the same position.

In FIG. 21, the similarity S of the vehicles can be calculated by the following expression:

S=1/{(w_d·|d1−d2|)+(w_θ·θ1−θ2|)}

where w_d represents a weight to a distance error and w_θ represents a weight to an angle error.

The vehicles may be determined to be more likely the same vehicle as a value of the similarity S calculated by the above expression increases.

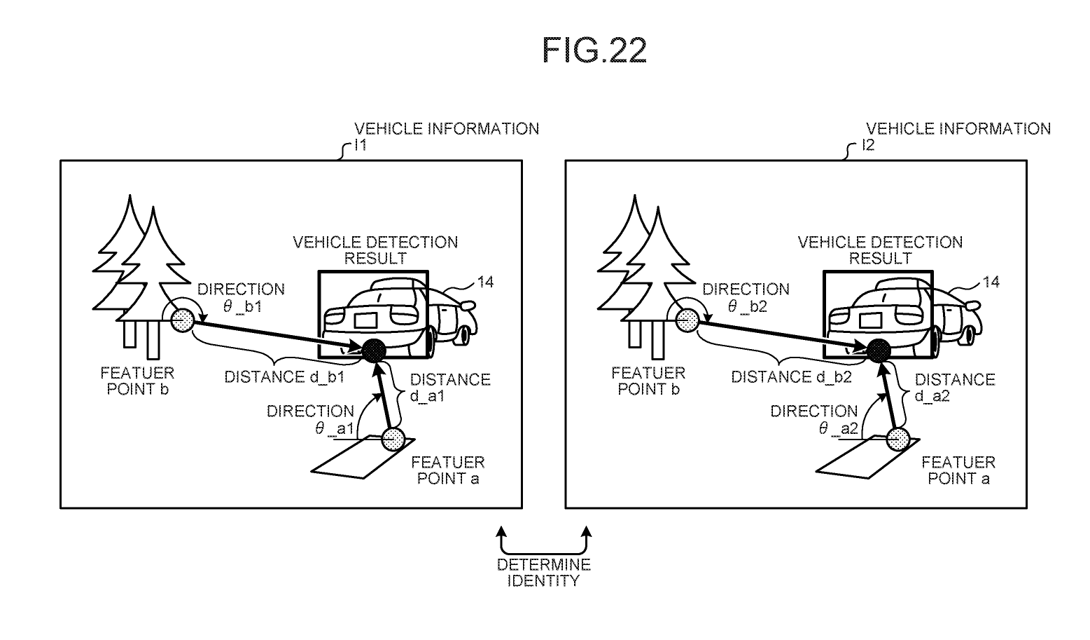

FIG. 22 is an explanatory diagram for a second determination method of the vehicle identity.

According to the second method, one or more feature points (, feature points a and b in FIG. 22) are extracted (calculated) from an image region of the captured image excluding the vehicle 14. If the relative position information on the feature points and the vehicle positions (in FIG. 22, distances d_a1, d_a2, d_b1, and d_b2, and directions θ_a1, θ_a2, θ_b1, and θ_b2) among the items of vehicle information are sufficiently similar to each other, the vehicles can be determined to be the same vehicle (parked vehicle) continuously stopping at the same position. The feature point extraction may be performed by a method, for example, described in “Distinctive Image Features from Scale-Invariant Keypoints”, D. G. Lowe, IJCV-2004.

Specifically, in FIG. 22, the similarity S is calculated from the weight w_d to a distance error and the weight w_θ to an angle error by the following expression:

S=1/{w_d·(|d_a1−d_a2|+|d_b1−d_b2|)+w_θ·(|θ_a1−θ_a2|+|θ_b1−θ_b2|)}

The vehicles may be determined to be more likely the same vehicle as the value of similarity S calculated by the above expression increases.

According to a third method, the vehicle identity is determined on the basis of image information of the vehicle.

That is, a determination is made on whether a plurality of items of vehicle information concern the same vehicle according to one or more items of information obtained from the image such as a color, a shape, a pattern, a size, and a number of the vehicle.

A vehicle size can be calculated from a position and a size in the image, and vehicle number information may be obtained by a known number plate reading technique.

With a sufficiently large similarity in the sizes or the vehicle numbers found, the vehicles can be determined to be the same vehicle. In addition, for identity determination based on the other information including the color, the shape, and the pattern, a cross-correlation value of the image of the vehicle region may be used as the similarity S.

Alternatively, the similarity S can be calculated by a more precise method as described in “Random ensemble metrics for object recognition”, T. Kozakaya et al., ICCV-2011.

With sufficiently large values of similarity S found, the vehicles can be determined to be the same vehicle.

Similarities S_i (i=1, 2, 3, . . . ) calculated from the color (i=1), the shape (i=2), the pattern (i=3), the size (i=4), and the vehicle number (i=5), . . . may be added with weights as needed, to obtain a total similarity SA for evaluation. The total similarity SA is obtained by the following expression:

SA=(w_1·S_1)+(w_2·S_2)+(w_3·S_3)+ . . .

A high possible parked vehicle can be determined according to a similarity threshold Sth with respect to the similarity S (or the total similarity SA) obtained by any of the above methods, such that the more largely a parked vehicle determination value EE=S/Sth exceeds 1.0, the higher the possibility of a parked vehicle is.

As described above, according to the fifth embodiment, it is made possible to surely and easily determine whether another vehicle 14 is a parked vehicle according to the result of the determination by the same vehicle determiner 61 in addition to the effects of the first embodiment.

### 6 Modification of Embodiments

The parked vehicle determination values EA, EB, EC, ED, and EE described in the first embodiment to the fifth embodiment may be individually used, or two or more of the determination values may be combined with their respective weights w_A, w_B, w_C, w_D, and w_E added to obtain a conclusive parked vehicle determination value EX. Specifically, for example, the parked vehicle determination value EX can be calculated by the following expression:

EX=w_A·EA+w_B·EB+w_C·EC+w_D·ED+w_E·EE

This makes it possible to more accurately discriminate a stopping vehicle in a traffic jam from a parked vehicle.

A plurality of images may be captured by the same host vehicle 14S while 14 circling around multiple times or by a plurality of vehicles (host vehicles 14S) while traveling through the same place.

The parked vehicle detection devices according to the above embodiments includes a control device such as a CPU, a storage device such as a read only memory (ROM) or a RAM, an external storage device such as an HDD, a CD drive device, or an SSD, a display apparatus such as a display device, and an input device such as a keyboard or a mouse, and has a hardware configuration utilizing a general computer.

The control program executed by the parked vehicle detection devices according to the above embodiments is recorded and provided in an installable or executable file format on a computer-readable recording medium such as a compact disc read only memory (CD-ROM), a flexible disk (FD), a compact disc recordable (CD-R), and a digital versatile disc (DVD).

The control program executed by the parked vehicle detection devices according to the above embodiments may be stored in a computer connected to a network such as the Internet and downloaded via the network. Furthermore, the control program executed by the parked vehicle detection devices according to the above embodiments may be provided or distributed via a network such as the Internet.

The control program of the parked vehicle detection devices according to the above embodiments may be incorporated in a ROM, for example.

The control program executed by the parked vehicle detection devices according to the above embodiments has a module configuration including the above-described elements (the vehicle detector, the host vehicle position detector, the position calculator, the vehicle information storage, the parked vehicle determiner, . . . ). As actual hardware, a CPU (processor) reads the control program from the storage medium and executes it to load the elements on a main storage device and generate the vehicle detector, the host vehicle position detector, the position calculator, the vehicle information storage, the parked vehicle determiner, . . . thereon.

Embodiments of the present invention have been described above. However, these embodiments are merely examples, and do not intend to limit the scope of the invention. These novel embodiments can be implemented in various other forms, and can be variously omitted, replaced, and modified without departing from the gist of the present invention. These embodiments and the modification thereof are included in the scope and the gist of the present invention, and also included in the invention described in Claims and an equivalent thereof.

1. A parked vehicle detection device comprising:
a vehicle detector that detects another vehicle included in an image of at least a front of a host vehicle, the image captured by an imaging device mounted on the host vehicle;
a host-vehicle position detector that detects a position of the host vehicle;
a position calculator that calculates a position of the detected another vehicle based on the detected position of the host vehicle;
a vehicle information storage that stores therein information on the another vehicle, the information including the calculated position; and
a parked vehicle determiner that determines whether the another vehicle is high possible parked vehicle based on the information on the another vehicle.

2. The parked vehicle detection device according to claim 1, further comprising:
a vehicle distance calculator that calculates a distance between other vehicles based on a plurality of items of information on the other vehicles stored in the vehicle information storage, wherein
the parked vehicle determiner determines the vehicle is high possible parked vehicle when the distance calculated by the vehicle distance calculator is equal to or larger than a predetermined vehicle distance.

3. The parked vehicle detection device according to claim 1, further comprising:
a vehicle velocity calculator that calculates a relative velocity of the detected another vehicle with respect to the host vehicle or an absolute velocity of the detected another vehicle based on the image, wherein
the parked vehicle determiner determines the vehicle as a parked vehicle when the absolute velocity of the another vehicle is equal to or smaller than a predetermined velocity that is regarded as parked.

4. The parked vehicle detection device according to claim 3, further comprising:
a velocity detector that detects a host vehicle velocity, the host vehicle velocity being an absolute velocity of the host vehicle; and
a distance calculator that calculates a distance to the another vehicle based on an image of the another vehicle included in the image, wherein
the vehicle velocity calculator calculates the absolute velocity of the another vehicle based on the host vehicle velocity and a relative velocity calculated based on a temporal change in the distance to the another vehicle corresponding to a plurality of images captured at different timings.

5. The parked vehicle detection device according to claim 1, further comprising:
a traveling-position change determiner that detects, based on the image, a lane change of the host vehicle to a lane different from a lane in which the another vehicle travels, wherein:
the position calculator calculates a position of the another vehicle when the host vehicle has made the lane change, and
the vehicle information storage stores therein information on the another vehicle, the information including the position when the change is made.

6. The parked vehicle detection device according to claim 5, wherein:
the traveling-position change determiner comprises an operation amount detector that detects a steering amount of the host vehicle, and
the traveling-position change determiner detects the lane change of the host vehicle based on the detected steering amount.

7. The parked vehicle detection device according to claim 5, wherein:
the traveling-position change determiner comprises a lane line position detector that detects a position of a lane line with respect to the host vehicle from the image, and
the traveling-position change determiner detects the lane change of the host vehicle based on a change amount of the position of the lane line with respect to the host vehicle.

8. The parked vehicle detection device according to claim 5, wherein:
the traveling-position change determiner comprises a vehicle position detector that detects a relative position between the another vehicle and the host vehicle from the image, and
the traveling-position change determiner detects the lane change of the host vehicle based on a change amount of the detected relative position between the another vehicle and the host vehicle.

9. The parked vehicle detection device according to claim 1, wherein the parked vehicle determiner determines whether the another vehicle is high possible parked vehicle based on a state of the detected another vehicle traveling in a plurality of lanes in a same direction and a temporal transition of the distance to the another vehicle.

10. The parked vehicle detection device according to claim 1, further comprising:
a same vehicle determiner that determines, when a plurality of images each including the another vehicle determined to stopping at the same position are captured by the imaging device at a predetermined time interval or larger, that the another vehicles included in the images is a same vehicle, wherein
the parked vehicle determiner determines that the another vehicles determined to be the same vehicle are high possible parked vehicles.

11. The parked vehicle detection device according to claim 10, wherein the same vehicle determiner determines whether the another vehicles are the same vehicle through pattern recognition.

12. The parked vehicle detection device according to claim 10, wherein:
the position calculator calculates relative positions of stop positions of the another vehicles with respect to characteristic objects in the images, and
the parked vehicle determiner determines, when the same vehicle determiner determines the relative positions of the stop positions of the another vehicles with respect to the characteristic objects in the images to be the same, that the another vehicles included in the images are stopping at a same geographic position.

13. The parked vehicle detection device according to claim 12, wherein the characteristic objects in the images include a background feature including a lane line.

14. A vehicle management system comprising:
a parked vehicle detection device that comprises: a vehicle detector that detects another vehicle included in an image of at least a front of a host vehicle, the image captured by an imaging device mounted on the host vehicle; a host vehicle position detector that detects a position of the host vehicle; a position calculator that calculates a position of the detected another vehicle based on the detected position of the host vehicle; a vehicle information storage that stores therein information on the another vehicle, the information including the calculated position; and a parked vehicle determiner that determines whether the another vehicle is high possible parked vehicle based on the information on the another vehicle; and
a management server device connected with the parked vehicle detection device via a communication network, wherein
the management server device receives items of parked vehicle information from parked vehicle detection devices, determines, based on the received parked vehicle information, other vehicles detected at a same position by the parked vehicle detection devices as a same vehicle parked at the position in a certain period of time, and processes information on the other vehicles as a parked vehicle.

15. A control method to be executed by a parked vehicle detection device mounted on a host vehicle including an imaging device, the control method comprising:
detecting another vehicle included in an image of at least a front of the host vehicle, the image captured by the imaging device mounted on the host vehicle;
detecting a position of the host vehicle;
calculating a position of the detected another vehicle based on the detected position of the host vehicle;
storing information on the another vehicle, the information including the calculated position; and
determining whether the another vehicle is high possible parked vehicle based on the information on the another vehicle.
